(19) United States
(12) Patent Application Publication
(10) Pub. No.: US 2014/0086698 A1
(43) Pub. Date: Mar. 27, 2014

(54) Drilling Tool

(71) Applicant: Ken Huddleston, Chester-le-Street (GB)

(72) Inventor: Ken Huddleston, Chester-le-Street (GB)

(73) Assignee: Thomas E. Sisson, San Antonio, TX (US)

(21) Appl. No.: 13/626,204

(22) Filed: Sep. 25, 2012

(51) Int. Cl. H02G 1/06

(52) U.S. Cl. 408/226

(57) ABSTRACT

A drilling tool for the installation of elongate members in walls comprises an elongate hollow shaft. The shaft has a proximate end and a distal end, the proximate end is provided with means for connection to a drill and the distal end is provided with means for connection to a drill bit so shaped and dimensioned that the drill bit forms a hole of a diameter greater than the maximum diameter of the shaft. The shaft comprises an aperture located at the proximate end of the shaft and adjacent to the means for connection to a drill, and an aperture located at the distal end of the shaft and adjacent to the means for connection to a drill bit.

### FIELD OF THE INVENTION

The invention relates to a drilling tool, and in particular to a drilling tool for installing elongate members in walls.

### BACKGROUND OF THE INVENTION

Stud walls are typically constructed from upright timber studs, strengthened by horizontal timber noggins stretching between the studs. Plasterboard is generally attached to the studs and the wall finished by applying plaster over the plasterboard.

The presence of horizontal noggins can cause problems when installing new pipework or cabling into a finished stud wall. Although the wall is hollow, holes or notches need to be drilled into the noggins to allow cabling or pipework to pass through.

Traditional methods for installing new wiring in a stud wall include removing sections of plasterboard at each noggin and drilling a hole or notch vertically through the noggin. Pipe or wire is then fed through each hole by hand before patching up the holes in the plasterboard. This is time consuming, fiddly, and ruins the finish on the wall.

Another method includes the use of a very long and flexible drill bit. Using a long drill bit the noggins can be drilled through from above by removing floor boards in the room above. Alternatively the noggins can be drilled through from below by removing a small section of plasterboard at the bottom of the wall. After the holes have been drilled the wire or pipe must be fed through the holes. This can be difficult since the holes are not necessarily located in line with each other.

US2007/0201963 describes a drilling tool for cabling through a wall. The tool comprises an elongate shaft with a drill bit at one end. The shaft creates a chaseway in the wall during the drilling process. After drilling through the wall the drill is disconnected from the shaft and cabling is inserted into the shaft. The drill bit must then be removed in order to pull the cable through the end of the shaft. The tool can then be removed from the wall.

FR2666040 describes a device for piercing partitions located between plasterboard panels. Holes are drilled using an elongate drill bit and then once drilled, wiring is then attachable to the drill bit end of then device and the wiring is then pulled back through the holes as the devices is withdrawn from the wall. The disadvantage of using such a tool are that the wire may become detached from the tool as it is drawn through the wall, or the wire may become stretched or otherwise damaged as it is pulled through the wall. A further disadvantage is the wiring must be pulled through in the reverse direction to which drilling has taken place.

It would be desirable to provide an improved tool for installing wiring or pipework into walls.

### SUMMARY OF THE INVENTION

One aspect of the invention provides a drilling tool for the installation of elongate members in walls comprising an elongate hollow shaft, the shaft having a proximate end and a distal end, the proximate end being provided with means for connection to a drill and the distal end being provided with means for connection to a drill bit to shaped and dimensioned that the drill bit forms a hold of a diameter greater than the maximum diameter of the shaft, wherein the shaft comprises an aperture located at the proximate end of the shaft and adjacent to the means for connection to a drill, and an aperture located at the distal end of the shaft and adjacent to the means for connection to a drill bit.

In use an elongate member may be introduced into the hollow shaft though one of the apertures, passed through the hollow shaft, and passed out of the hollow shaft through the other aperture without removal of the drill or the drill bit from the tool.

Preferably, each aperture is located along the length of the elongate hollow shaft.

The elongate members being installed in walls may be cabling, wiring or pipework.

Preferably the shaft comprises at least two disconnectable portion. The proximate end of the shaft may form part of a top portion of the shaft and the distal end of the shaft may form part of a bottom portion. More preferably the drilling tool further comprises a central portion, wherein the central portion is connectable between the top portion and the bottom portion. Additional extension portions may form part of the shaft in order to further extend the length of the drilling tool. The drilling tool is easily transportable since the elongate shaft comprises a number of disconnectable portions.

Preferably the portions of the shaft are connectable together using a screw threaded connection. Alternatively, the portions of the shaft are connectable using a connecting sleeve. The connecting sleeve may be connectable to the portions of the shaft using a screw threaded connection. Connecting portions of the shaft may be castellated in shape. Castellation of the connecting portions of the shaft allows the two connecting portions to interlock, ensuring a good connection between the two portions.

Alternatively, the portions of the shaft are connectable together using a push fit connection. Preferably the aperture located at the distal end of the shaft is chamfered towards the distal end of the shaft. This provides an angled guide which helps to guide elongate members out of the aperture located at the distal end of the shaft.

The drilling tool may include a drill bit. The drill bit may be a flat head drill bit or a cross head drill bit.

Preferably the proximate end of the shaft further comprises a portion with diameter greater than the diameter of the hole formed by the drill bit. This prevents the tool falling through the hole after it has been drilled.

The drilling tool of the invention allows elongate members such as wiring, cabling or pipework to be easily installed in, or through a wall. The tool allows the job to be completed quickly and easily by one installer, with minimal damage to the finish of the original wall.

### BRIEF DESCRIPTION OF THE DRAWINGS

In the drawings, which illustrate preferred embodiments of the invention.

FIG. 1 illustrates a front view of an embodiment of a drilling tool of the invention;

FIG. 2a illustrates a front view of a top and bottom portion of a drilling tool of the invention;

FIG. 2b illustrates a side view of the top and bottom portions of the drilling tool of FIG. 2a;

FIG. 2c illustrates a front view of a central portion of a drilling tool of the invention;

FIG. 3a illustrates a perspective view of a joint sleeve for use with a drilling tool of the invention;

FIG. 3b illustrates a plan view of the joint sleeve of FIG. 3a;

FIG. 4 illustrates the drilling tool of FIG. 1 in use in a stud wall;

FIG. 5a illustrates an alternative embodiment of a joint assembly for joining portions of the drilling tool together using a connecting sleeve; and

FIG. 5b is a side on view of the joint assembly of FIG. 5a with the connecting sleeve shown cutaway.

### DETAILED DESCRIPTION OF THE PREFERRED EMBODIMENTS

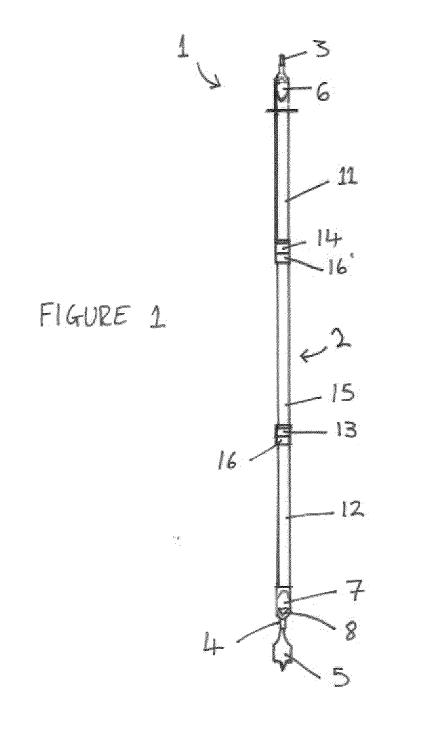

As shown in FIG. 1, a drilling tool 1 comprises a hollow, elongate shaft 2. In this example the elongate shaft 2 is constructed of three disconnectable portions; a top portion 11, a middle portion 15, and a bottom portion 12. The top end 3 of the tool 1 is shaped such that it is connectable to a drill (not shown). The bottom end of the tool 1 is provided with a drill bit holder 4 designed to hold a drill bit 5. The drill bit 5 must be shaped such that the hole it creates is greater in diameter than the maximum diameter of the shaft 2 in order to allow the shaft 2 to pass through any drilled holes. The shaft 2 is provided with a hole, or aperture 6 situated towards the top end of the tool 1 and a second hole, or aperture 7 situated towards the bottom end of the tool 1, close to the drill bit holder 4. As illustrated in the Figures these holes 6, 7 are located along the length of the elongate shaft, adjacent to the respective ends of the tool 1. These holes 6, 7 allow passage of wiring or flexible tubing through the hollow shaft 2. Preferably, the second hole 7 is provided with a bevelled or chamfered exit portion 8 which helps to guide the wiring or tubing out of the second hole.

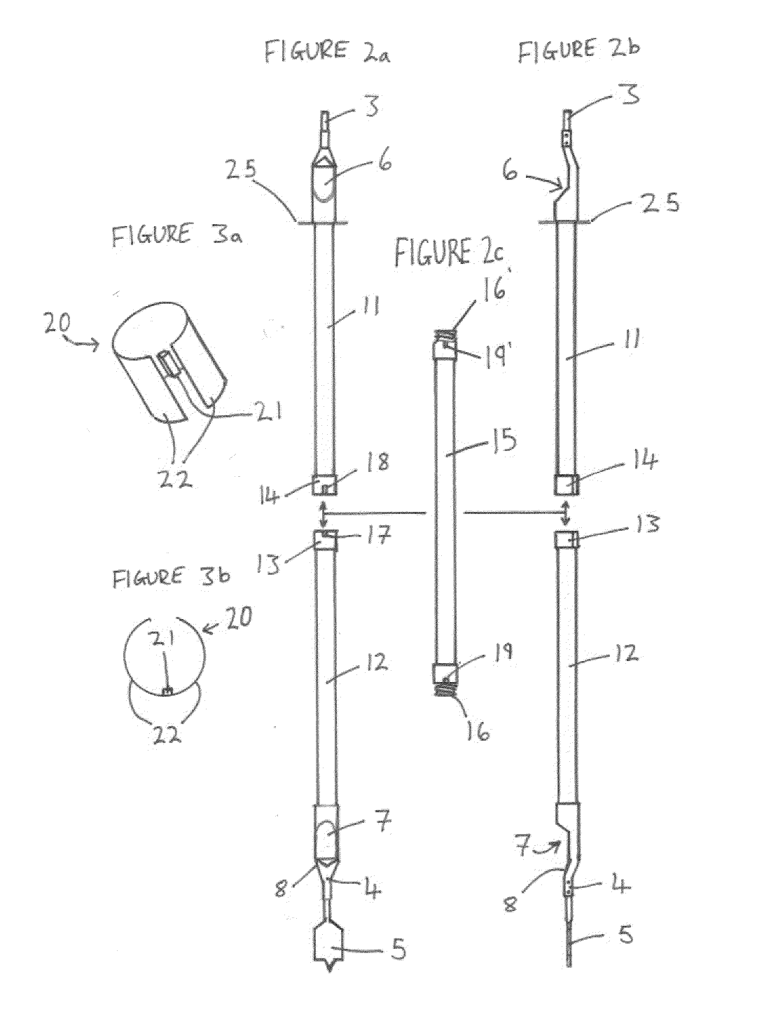

In the example illustrated in FIG. 1 the tool is provided with a flange 25 at the top end of the tool, located underneath the hole 6. The flange 25 has a diameter larger than the diameter of the hole to be drilled and serves to prevent the tool 1 from falling through a drilled hole and into the wall cavity. In a preferred embodiment of the invention, as illustrated in FIGS. 1 and 2, the drilling tool is made up of three separate portions 11, 12 and 15 which are connected together. The separate portions 11, 12, and 15 of the drilling tool 1 are illustrated more clearly in FIGS. 2a-c.

FIGS. 2a and 2b illustrate the top and bottom portions 11, 12 of the drilling tool 1. The top portion 11 of the drilling tool is connectable to a drill at one end 3 and is provided with an internally threaded female collar 14 at the other end. The bottom portion 12 of the drilling tool 1 is provided with a drill bit holder 4 at one end, and a female threaded collar 13 at the other end. These female threaded collars 13, 14 are each connectable to a corresponding male threaded collar 16, 16′ located at either end of a central tool portion 15 shown in FIG. 2c.

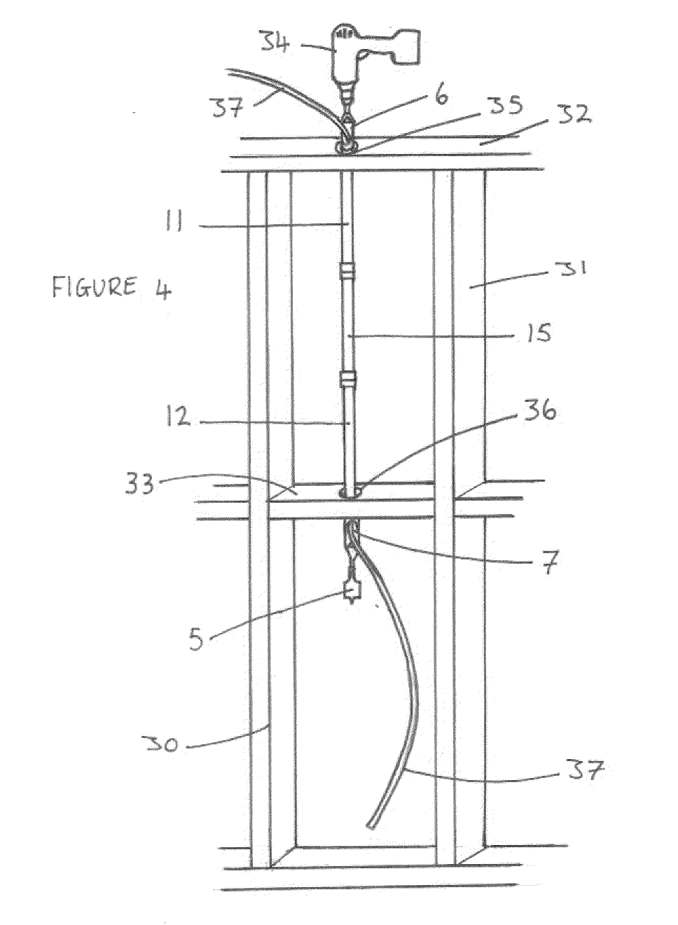

The threaded collars 13, 14, 16, 16′ may each be provided with notches 17, 18, 19, 19′. When the top 11, bottom 12 and central 15 portions of the tool are connected together the notches on the collars are aligned when the screw threads are tightened with optimal tightness. For example, notch 17 on collar 13 is aligned with notch 19 on collar 16 when the central tool portion 15 and bottom tool portion 12 are connected together; and notch 18 on collar 14 is aligned with notch 19′ on collar 16′ when the central tool portion 15 and top tool portion 11 are connected together. A joint sleeve 20 shown in FIGS. 3a and 3b may then be placed over the connected collars. The joint sleeve 20 includes a locking tab 21 which is shaped such that it locates within the aligned notches. The arms 22 of the joint sleeve 20 are made of a resilient material and can easily be placed over the connected collars. The use of a joint sleeve 20 helps to lock the portions of the shaft together, and prevents the joints of the tool from being over-tightened, or loosened.

Although the examples show male/female screw thread connections between the different portions of the shaft of the drilling tool, alternative methods of connection could be envisaged, such as push-fit or bayonet connections. In addition, the location of the male/female thread connections could be reversed or interchanged.

FIG. 4 illustrates an installation of wiring using the drilling tool of the invention in a stud wall. The plasterboard is not shown for clarity. The stud wall includes upright timber studs 30, 31, a top horizontal timber 32 and a horizontal timber noggin 33. The installer is drilling down through the wall from the floor above. To begin the job the installed connects a standard power drill 34 to a drill bit of the same diameter as that of the drilling tool and drills a vertical hole 35 through the top timber 32. The installer next connects a drilling tool to the drill 34, the drilling tool comprising a top portion 11, a bottom portion 12, and a central portion 15. The drilling tool can pass freely through the hole 35 until it reaches the horizontal noggin 33. A vertical hole 36 is then drilled through the noggin 33 using the drilling tool. The drilling tool can pass freely through the hole 36. The tool now reaches the bottom of the wall. Wiring 37 can now be passed through the top hole 6 in the top portion 11 of the drilling tool through the hollow shaft 2 of the drilling tool, and finally exits the drilling tool through the bottom hole in the bottom portion 12 of the drilling tool. There is no need to remove the drill 34 from the tool before inserting the wiring 37 into the top hole 6. Typically, a hole for receiving an electrical socket box would be cut into the plasterboard towards the bottom of the wall and the wiring 37 would be drawn out through the hole in the plasterboard and wired into the socket in the normal manner. After the wiring 37 has been passed through the drilling tool the tool can be withdrawn, leaving the wiring 37 installed in the wall.

In many cases, especially in newly constructed stud wall, the stud walls only contain one horizontal noggin situated roughly in the centre of the wall, as described above. When more than one noggin is present the installer simply drills a further hole through the additional noggin or noggins. The drilling tool may be extended where required using additional extension portions (not shown). In the example illustrated extension portions would be required to be provided with a male threaded collar at one end and a female threaded collar at the other end. In situations where there is limited height access, for example in a loft space, the drilling tool may be introduced into the wall in sections after the first access hole through the top timber has been drilled.

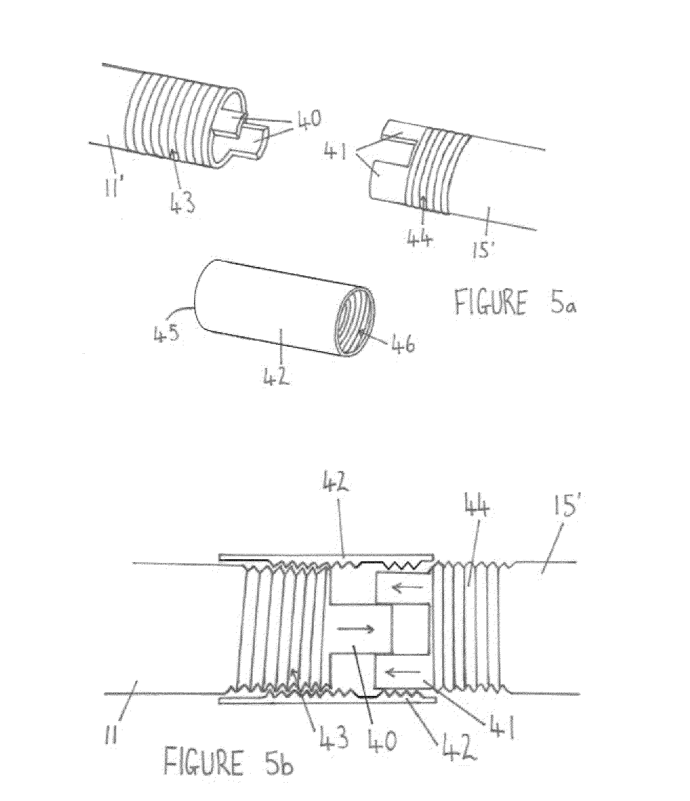

FIGS. 5a and 5b illustrate an alternative joint assembly for joining portions of the drilling tool together. In this embodiment of the invention portions of the tool 11′ and 15′ are not screwed together, instead they are connected together using a separate connecting sleeve. The connecting portions 40, 41 of the drilling tool are also castellated in shape to ensure a good connection between the portions of the tool 11′ and 15′. The ends of the tool portions 11′, 15′ which connect together are also each provided with a screw thread. In this example the end of the top portion 11′ is externally threaded with a left handed screw threaded portion 43, located immediately adjacent to the castellated portion 40. The connecting end of the middle portion of the tool 15′ is externally threaded with a right handed screw threaded portion 44, located immediately adjacent to the castellated portion 41. A connecting sleeve 42 is sized to fit over the end of each portion of the tool 11′, 15′. The connecting sleeve 42 is provided with an internal screw thread at both ends. The sleeve 42 is provided with a left handed internal screw thread at one end 45 and a right handed internal screw thread at the other end 46. The left hand screw threaded end 46 of the sleeve 42 is partially screwed onto the left handed screw threaded end 43 of the top portion 11′ of the tool. The right handed screw threaded end 44 of the middle portion 15′ of the tool is then introduced into the other end of the sleeve 42, oriented such that the castellated connecting portions 40, 41 interlock. The sleeve 42 is then turned in a clockwise direction, causing the castellated joints 40, 41 to move together as indicated in FIG. 5b, forming a tight connection between the two portions 11′, 15′ of the drilling tool. The same type of joint maybe used to connect the lower portion of the drilling tool to the middle portion (not shown).

The drilling tool of the invention is equally suited to the insertion of cables or other elongate members through walls or cavity walls using a suitable masonry drill bit.

What is claimed is:

1. A drilling tool for the installation of elongate members in walls comprising an elongate hollow shaft, the shaft having a proximate end and a distal end, the proximate end being provided with means for connection to a drill and the distal end being provided with means for connection to a drill bit so shaped and dimensioned that the drill bit forms a hole of a diameter greater than the maximum diameter of the shaft, wherein the shaft comprises an aperture located at the proximate end of the shaft and adjacent to the means for connection to a drill, and an aperture located at the distal end of the shaft and adjacent to the means for connection to a drill bit.

2. A drilling tool according to claim 1, wherein each aperture is located along the length of the elongate hollow shaft.

3. A drilling tool according to claim 1, the shaft comprising at least two disconnectable portions, wherein the proximate end of the shaft forms part of a top portion and the distal end of the shaft forms part of a bottom portion.

4. A drilling tool according to claim 3, further comprising a central portion, wherein the central portion is connectable between the top portion and the bottom portion.

5. A drilling tool according to claim 3, wherein the portions of the shaft are connectable via screw thread connections.

6. A drilling tool according to claim 5, further comprising means for locking the disconnectable portions of the shaft together.

7. A drilling tool according to claim 6, wherein the locking means comprises a resilient sleeve with a protrusion located on the sleeve, and the disconnectable portions of the shaft comprise notches in which the protrusion on the sleeve locates.

8. A drilling tool according to claim 3, wherein the portions of the shaft are connectable using a connecting sleeve.

9. A drilling tool according to claim 8, wherein the connecting sleeve is connectable to the portions of the shaft using screw threaded connections.

10. A drilling tool according to claim 8, wherein the connecting portions of the shaft are castellated in shape.

11. A drilling tool according to claim 1, wherein the aperture located at the distal end of the shaft is chamfered towards the distal end of the shaft.

12. A drilling tool according to claim 1, further comprising a drill bit.

13. A drilling tool according to claim 1, the proximate end of the shaft further comprising a portion with diameter greater than the diameter of the hole formed by the drill bit.
